(19) United States
(12) Patent Application Publication
(10) Pub. No.: US 2005/0096403 A1
(43) Pub. Date: May 5, 2005

(54) Method of making polyurea containing automobile body parts

(76) Inventors: Allan James, Camlachie (CA); Kenneth B. Arnold, Lake Jackson, TX (US)

Correspondence Address: LOCKE LIDDELL & SAPP LLP, 600 TRAVIS, 3400 CHASE TOWER, HOUSTON, TX, 77002-3095, US

(21) Appl. No.: 10/997,378

(22) Filed: Nov. 24, 2004

Related U.S. Application Data
(63) Continuation of application No. 09/733,286, filed on Dec. 8, 2000, now abandoned.
(60) Provisional application No. 60/170,294, filed on Dec. 10, 1999.

(51) Int. Cl. C08J 9/00; C08G 18/00

(52) U.S. Cl. 521/128; 528/44

(57) ABSTRACT

A polyurea-polymer formulation suitable for preparing a molded polyurea polymer includes a polyisocyanate, an isocyanate-reactive material, and a fatty-acid ester. The fatty-acid ester is present in an amount effective for providing a molded polyurea polymer prepared from the formulation with blister resistance such that when the molded polyurea polymer is exposed to moisture and a temperature of at least about 350° F. (177° C.), the molded polyurea polymer is substantially free of blisters. A fatty-acid ester suitable for use with these formulations can be natural or synthetic, and one example includes jojoba oil. A polyurea-polymer formulation can also include other components known to be useful with polyurea polymers such as fillers, catalysts, surfactants, and polyepoxides. A molded polyurea polymer can be prepared from a polyurea-polymer formulation. One method suitable for preparing a molded polyurea polymer includes reaction injection molding.

### CROSS-REFERENCE STATEMENT

This application claims the benefit of U.S. Provisional Application No. 60/170,294, filed Dec. 10, 1999, which is hereby incorporated by reference.

### FIELD OF THE INVENTION

This invention relates to polyurea polymers and polyurea-polymer formulations and to methods of making polyurea polymers and polyurea-polymer formulations. More particularly, this invention is directed to polyurea-polymer formulations that include a fatty-acid ester in an amount effective for providing blister resistance to a molded polyurea polymer prepared from a polyurea-polymer formulation.

### BACKGROUND OF THE INVENTION

It is known in the art that isocyanate-based polymers can be useful for preparing moldings such as automobile fascia and body panels. These isocyanate-based polymers include polyurea polymers. For example, U.S. Pat. No. 4,218,543 issued to Weber et al. discloses preparing elastomeric moldings by a reaction-injection-molding (RIM) process.

But polyurea polymers can be problematic in some applications. When a polyurea polymer is molded into, for example, a RIM part such as automobile fascia or automobile body panels, and the molded polymer is first exposed to moisture and then exposed to a high temperature such as a temperature greater than 350° F. (177° C.), surface defects in the molded polymer can be observed. These defects can be particularly problematic when mica is used as a filler in a polyurea-polymer formulation.

In one common application, which is reaction injection molding of body parts for automobiles, a molded polymer can be exposed to temperatures exceeding 350° F. (177° C.). Moreover, these body parts can further be subjected to even higher temperatures when the parts are assembled onto an automobile and the automobile is subjected to known production conditions, such as an e-coat process. For example, the parts assembled onto an automobile can be subjected to temperatures up to 400° F. (204° C.) for up to 30 minutes under general production conditions and sometimes for up to 60 minutes under experimental production conditions.

If a molded polymer contains too much water when it is exposed to heat, it can exhibit surface defects commonly known in the art as blistering. Blistering generally occurs when moisture absorbed into the molded polymer interacts with the polymer to produce gas and the gas accumulates to form a gas pocket. In a laboratory, blister resistance is measured by soaking a test panel for two days in water and then exposing the panel to elevated temperatures. The temperature at which the panel fails is identified as the panel's temperature-capable point.

One approach that has been used to overcome this blistering problem includes substituting wollastonite for mica as a filler. Another approach that has been used includes admixing a polyepoxide with a polyisocyanate and a polyamine. For example, U.S. Pat. No. 5,525,681 issued to Barron et al. teaches polyurea polymers prepared from formulations including a polyisocyanate, a polyamine, and a polyepoxide. But, in some instances, these types of formulations, such as when mica is used as a filler, can lead to molded polymers that have a brittleness that is less than desirable for production conditions.

Other solutions to address the blistering problem, such as avoiding exposure to high temperatures or moisture, are less than desirable because of properties that can be provided to a molded polymer from such exposure or because of unavoidable process or manufacturing conditions that a molded polymer can be exposed to.

Thus, it would be desirable to prepare alternative polyurea polymers that can remain substantially free of blisters when exposed to moisture and elevated temperatures suitable for traditional production conditions such as postcuring and e-coat conditions.

### SUMMARY OF THE INVENTION

According to the invention, a polyurea-polymer formulation suitable for preparing a molded polyurea polymer includes a polyisocyanate, an isocyanate-reactive material, and a fatty-acid ester. The fatty-acid ester is present in an amount effective for providing blister resistance to a molded polyurea polymer prepared from the formulation such that when the molded polyurea polymer is exposed to moisture and a temperature of at least 350° F. (177° C.), the molded polyurea polymer is substantially free of blisters.

In one embodiment, the fatty-acid ester includes jojoba oil.

In another embodiment, the formulation further includes at least one of a chain extender, a catalyst, a surfactant, and an internal-mold-release agent. The formulation can also include a polyepoxide.

A molded polyurea polymer can be prepared from a polyurea-polymer formulation of the invention by admixing a polyisocyanate, an isocyanate-reactive material, and a fatty-acid ester to form a mixture, and molding the mixture by using reaction injection molding.

A method for preparing a polyurea-polymer formulation of the invention includes admixing a polyisocyanate, an isocyanate-reactive material, and a fatty-acid ester to form a mixture. The fatty-acid ester is added in an amount effective for providing blister resistance to a molded polyurea polymer prepared from the mixture such that when the molded polyurea polymer is exposed to moisture and a temperature of at least 350° F. (177° C.), the molded polyurea polymer is substantially free of blisters.

### DETAILED DESCRIPTION OF THE INVENTION

The invention is directed to a polyurea-polymer formulation that can be used to prepare a molded polyurea polymer having blister resistance. The invention is further directed to a method of preparing a polyurea-polymer formulation that can be used to prepare a molded polyurea polymer having blister resistance. The invention is still further directed to a method of improving blister resistance of a molded polyurea polymer that is prepared from a polyurea-polymer formulation by adding a fatty-acid ester to a polyurea-polymer formulation.

Composition

A polyurea-polymer formulation of the invention generally includes at least one polyisocyanate, at least one isocyanate-reactive material, and at least one fatty-acid ester. The fatty-acid ester is included in an amount effective for providing a molded polyurea polymer prepared from the formulation with blister resistance. Blister resistance means that when the molded polyurea polymer is exposed to moisture and a temperature of at least about 350° F. (177° C.), the molded polyurea polymer is substantially free of blisters. A polyurea-polymer formulation of the invention can also include other components known to be useful with polyurea polymers, particularly fillers, catalysts, surfactants, and polyepoxides.

Fatty-Acid Ester

A polyurea-polymer formulation of the invention includes a fatty-acid ester. Any fatty-acid ester suitable for providing a molded polyurea polymer prepared from a formulation of the invention with blister resistance or improved blister resistance can be used in a formulation of the invention. Suitable fatty-acid esters include both natural fatty-acid esters and synthetic fatty-acid esters.

Examples of natural fatty-acid esters include the following oils: canola, castor, coconut, cotton seed, flax seed, hemp seed, jojoba, olive, palm, peanut, pumpkin seed, safflower, sesame, soybean, and sunflower.

Examples of synthetic fatty-acid esters include compounds such as glycerine trioleate and pentaerythritol tetraoleate and commercial esters such as Loxiol* G71S from Henkel Corporation and Polyaldo* DGDO from Lonza, Inc.

Synthetic fatty-acid esters suitable for use in the invention can be prepared from known methods. Generally a synthetic fatty-acid ester can be prepared from reacting a fatty acid with at least one of an alcohol, an amino alcohol, and an amine. Fatty acids suitable for preparing a synthetic fatty-acid ester are known and include saturated fatty acids, unsaturated fatty acids, or a combination of saturated and unsaturated fatty acids.

Examples of suitable fatty acids include ricinoleic acid; oleic acid; alaidic acid; stearic acid; palmitic acid; linoleic acid; octanoic acids; acids obtained from coconut oil; tallow fatty acids; acids obtained from paraffin oxidation; and tall-oil fatty acids. Preferably the fatty acid is oleic acid, linoleic acid, adipic acid, ricinoleic acid, or a combination of these acids. More preferably the fatty acid is oleic acid.

Amines and amino alcohols suitable for reacting with a fatty acid to prepare a synthetic fatty-acid ester are known and include, for example, ammonia; monoalkylamines such as methylamine; dialkylamines such as diethylamine; and amine alkoxylation products such as ethanolamine. When a fatty acid is reacted with an amine or an amino alcohol, a mixture of a fatty-acid ester and a fatty-acid amide is typically produced. This mixture can be used in a method or a composition of the invention.

Alcohols suitable for reacting with a fatty acid to prepare a synthetic fatty-acid ester are known and include, for example, butanol; hexanol; isomers of octanol; dodecanol; oleyl alcohol; natural or synthetic steroid alcohols; ricinoleic acid; ethylene glycol; propylene glycol; butanediols; hexanediols; glycerol; polyglycerol; trimethylolpropane; pentaerythritol; sorbitol; hexitol; and various sugars or addition products of alkylene oxides such-as ethylene oxide or propylene oxide.

Preferably a synthetic fatty-acid ester is prepared by condensation of an alcohol and a fatty acid at elevated temperatures, which is a known method. The temperature at which the reaction is conducted can be any temperature at which water is formed by reaction of the acid with the alcohol. The reaction temperature can depend on other factors such as whether a catalyst is used, the nature and type of the catalyst, and the amount of catalyst present. The catalyst can be either acidic or basic. The reaction is preferably conducted at a temperature above about 212° F. (100° C.), more preferably above about 248° F. (120° C.), and even more preferably above about 302° F. (150° C.). The temperature preferably is less than about 392° F. (200° C.). Such a reaction can be conducted in a vacuum, and water can be removed from the reaction mixture by, for example, azeotropic distillation. But neither the use of a vacuum or removal of water is required.

A fatty-acid ester can be added to a polyurea-polymer formulation in an amount effective to improve blister resistance of a molded polyurea polymer prepared from a polyurea-polymer formulation of the invention as compared to blister resistance of a molded polyurea polymer prepared from a polyurea-polymer formulation that is substantially free of a fatty-acid ester.

A fatty-acid ester can also be added in an amount effective for providing a molded polyurea polymer prepared from a polyurea-polymer formulation of the invention with blister resistance such that when the molded polyurea-polymer formulation is exposed to moisture and a temperature of at least about 350° F. (177° C.), preferably at least about 375° F. (190° C.), more preferably at least about 390° F. (199° C.), and still more preferably at least about 400° F. (204° C.), the molded formulation is substantially free of blisters. Generally the temperature is no greater than about 425° F. (218° C.), preferably no greater than about 415° F. (213° C.), and more preferably no greater than about 405° F. (207° C.).

A molded polyurea polymer can be exposed to such a temperature for time periods generally used for production conditions such as time periods suitable for postcuring a molded polyurea polymer or time periods suitable for subjecting an automobile having a molded polyurea polymer to, for example, an e-coat process. Typically a molded polyurea polymer can be exposed to such a temperature for at least about 20 minutes, preferably at least about 25 minutes, and more preferably at least about 30 minutes. Generally the exposure is not longer than about 60 minutes, preferably no longer than about 50 minutes, and more preferably no longer than about 45 minutes.

The exposure to moisture generally results in the molded polyurea polymer taking up no more than about 2 weight-percent water based on the weight of the molded polyurea polymer, preferably no more than about 1.5 weight-percent water, and more preferably no more than about 1.0 weight-percent water. Generally the molded polyurea polymer can take up between about 1.0 and about 1.5 weight-percent water based on the weight of the molded polyurea polymer.

Typically a fatty-acid ester is added to a polyurea-polymer formulation in an amount of at least about 0.5 weight percent, preferably at least about 1.5 weight percent, and more preferably at least about 2 weight percent. But a fatty-acid ester should not be added in such a large amount that the formulation becomes prohibitively expensive, becomes substantially difficult to process, or cannot be used for its intended purpose. A fatty-acid ester is generally added in an amount no greater than about 5.0 weight percent, preferably no greater than about 4 weight percent, and more preferably no greater than about 3 weight percent. The weight percent of fatty-acid ester is based on the weight of the reaction mixture that contains the isocyanate-reactive material, which is conventionally known as the B-side reactant. The B-side reactant generally reacts with the polyisocyanate, which is conventionally known as the A-side reactant, in the chemistry used to make a polyurea polymer.

Polyisocyanate

The polyurea-polymer formulation of the invention includes a polyisocyanate. A polyisocyanate suitable for use with a formulation of the invention includes any polyisocyanate suitable for preparing a molded polyurea polymer.

A polyisocyanate can be advantageously selected from organic polyisocyanates, modified polyisocyanates, isocyanate-based prepolymers, and mixtures thereof. These can include aliphatic and cycloaliphatic isocyanates, but multifunctional and particularly difunctional aromatic isocyanates are preferred. Preferred are 2,4- and 2,6-toluenediisocyanate (TDI) and the corresponding isomeric mixtures; 4,4′-, 2,4′-, and 2,2′-diiphenylmethanediisocyanate (MDI); mixtures of 4′,4′-, 2,4′-, and 2,2′-MDI and polyphenyl polymethylene polyisocyanates (PMDI); and mixtures of PMDI and TDI.

Also useful for preparing the polyureas of the invention are aliphatic and cycloaliphatic isocyanate compounds such as 1,6-hexamethylenediisocyanate; 1-isocyanato-3,5,5-trimethyl-1-3-isocyanatomethyl cyclohexane; 2,4- and 2,6-hexanhydrotoluenediisocyanate. The corresponding isomeric mixtures: 4,4′-, 2,2′-, and 2,4′-dicyclohexylmethanediisocyanate as well as the corresponding isomeric mixtures can also be used. Isophorone diisocyanate can also be used with the invention.

Also advantageously used for the polyisocyanate are the so-called modified multifunctional isocyanates, that is, products that are obtained through chemical reactions of the above polyisocyanates. Examples of such polyisocyanates include polyisocyanates containing at least one of esters, ureas, biurets, allophanates, carbodiimides, uretonimines, and urethane groups containing diisocyanates or polyisocyanates.

Polyisocyanates containing at least one of a carbodiimide group and a uretonimine group and having an isocyanate group (NCO) content of from about 10 to about 40 weight percent based on the total weight of isocyanate prepolymer, more preferably from about 20 to about 35 weight percent, can also be used. These include, for example, polyisocyanates based on 4,4′-, 2,4′-, or 2,2′-MDI, the corresponding isomeric mixtures, and mixtures thereof; 2,4-, 2,6-TDI, the corresponding isomeric mixtures, and mixtures thereof; and mixtures of MDI and PMDI, mixtures of TDI and PMDI, diphenylmethane diisocyanates, and mixtures thereof.

Suitable and preferred are prepolymers having an NCO content of from about 5 to about 40 weight percent based on the total weight of isocyanate prepolymer and more preferably from about 15 to about 30 weight percent. These prepolymers are prepared by reaction of the polyisocyanates with materials including lower molecular weight diols or triols, but also they can be prepared with multivalent active hydrogen compounds such as di- and tri-amines and di- and tri-thiols. Individual examples are aromatic polyisocyanates containing urethane groups, preferably having an NCO content of from 5 to 40 weight percent, more preferably 10 to 35 weight percent, obtained by reaction of polyisocyanates with, for example, lower molecular weight diols, triols, oxyalkylene glycols, dioxyalkylene glycols, or polyoxyalkylene glycols having molecular weights up to 800. These polyols can be employed individually or in mixtures as di- and/or polyoxyalkylene glycols. For example, diethylene glycols, dipropylene glycols, polyoxyethylene glycols, polyoxypropylene glycols, and polyoxypropylene-polyoxyethylene glycols can be used.

Even more preferred for use in the invention are: (i) polyisocyanates having an NCO content of from about 8 to about 40 weight percent based on the total weight of isocyanate prepolymer and containing carbodiimide groups and/or urethane groups, from 4,4′-MDI or a mixture of 4,4′- and 2,4′-MDI; (ii) prepolymers containing NCO groups, having an NCO content of from about 10 to about 35 weight percent, based on the weight of the prepolymer, prepared by the reaction of polyoxyalkylene polyols, having a functionality of preferably from 2 to 4 and a molecular weight of from about 800 to about 15,000 with 4,4′-diphenylmethane diisocyanate or with a mixture of 4,4′- and 2,4′-MDI and mixtures of (i) and (ii); and (iii) 2,4- and 2,6-TDI and the corresponding isomeric mixtures.

Isocyanate-Reactive Material

A polyurea-polymer formulation of the invention also includes an isocyanate-reactive material such as a polyamine. Any polyamine suitable for preparing a molded polyurea polymer can be used in a formulation of the invention.

A polyamine includes any amine compound having at least two isocyanate-reactive hydrogens per molecule. Preferably all isocyanate-reactive hydrogens of the polyamine are amine-group hydrogens. Examples of such polyamines include alkylene polyamines represented by the formula:
NH₂C₂H₄(NHC₂H₄)ₙX
where X is —OH or —NH₂ and where n has the value of 0 to 5. When X is —NH₂, such alkylene polyamines include ethylene diamine, diethylene triamine, triethylene tetramine, tetraethylene pentamine, and pentaethylene hexamine.

Aromatic amines can be used with the invention as well. Examples of aromatic polyamines include 2,4 and 2,6-toluenediamine, n-aminoethylpiperazine, m-phenylenediamine. Particularly useful with the invention are diethyltoluenediamine and di-tert-butyl-toluenediamine.

A particularly useful group of amines are amines derived from polyoxypropylene diols and triols. Preferably these diamines have the formula:
H₂NCH(CH₃)CH₂[OCH₂CH(CH₃)]ₓNH₂
wherein x is an integer of from 2 to 40, and the triamines have the formula: 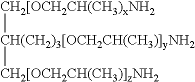
wherein x, y, and z represent integers in the range of from 1 to 15, and the sum of x, y, and z is from 3 to 45. The most preferred polyoxypropylene diamines have an average molecular weight of from about 230 to about 2000. The most preferred polyoxypropylene triamines have an average molecular weight of from about 190 to about 5000. Also useful are diamines having the formula:
H₂NCH(CH₃)CH₂[OCH(CH₃)CH₂]ₓ[OCH₂CH₂]_{y}[OCH₂CH(CH₃)_{z}NH₂
wherein x+z equals 2 to 10 and y is an integer from 1 to 50.

Care should be exercised in choosing the polyisocyanate and polyamine for use in a formulation of the invention. Primary amines and aromatic polyisocyanates are particularly mutually reactive. Forming polymers from such components can be very difficult because the reaction can be rapid and very exothermic, thereby preventing the formation of a homogenous polymer. Therefore, one should choose polyisocyanate and polyamine components that have a mutual reactivity suitable for preparing the desired polyurea polymer. One skilled in the art having read this specification would understand how to choose desirable polyisocyanates and polyamines.

Polyurea-polymer formulations of the invention can also include other isocyanate-reactive materials besides a polyamine or in combination with a polyamine. For example, a polyurea-polymer formulation of the invention can also include polyether or polyester polyols. These types of isocyanate-reactive materials are generally used to prepare polyurethane polymers. Active hydrogen-containing compounds most commonly used in polyurethane production are those compounds having at least two hydroxyl groups. Those compounds are referred to herein as polyols. The resultant polymers can also have improved physical properties compared to otherwise similar conventional polymers.

The terms “polyurea polymer” and “polyurea-polymer formulation” are intended to include both polyurea and polyurethane polymers as well as a combination of polyurea and polyurethane polymers and their corresponding formulations.

Representative polyols suitable for use in the invention are generally known and are described in such publications as High Polymers, Vol. XVI, “Polyurethanes, Chemistry and Technology” by Saunders and Frisch, Interscience Publishers, New York, Vol. I, pp. 32-42, 444-54 (1962) and Vol. II, pp. 5-6, 198-199 (1964); Organic Polymer Chemistry by K. J. Saunders, Chapman and Hall, London, pp. 323-325 (1973); and Developments in Polyurethanes, Vol. 1, I. M. Burst, ed., Applied Science Publishers, pp. 1-76 (1978).

But any active hydrogen-containing compound can be used with this invention. Examples of such materials include those selected from the following classes of composition, alone or in mixture: (a) alkylene oxide adducts of polyhydroxyalkanes; (b) alkylene oxide adducts of nonreducing sugars and sugar derivatives; (c) alkylene oxide adducts of phosphorus and polyphosphorus acids; and (d) alkylene oxide adducts of polyphenols. Polyols of these types are referred to herein as “base polyols.” Examples of alkylene oxide adducts of polyhydroxyalkanes useful according to the invention are adducts of ethylene glycol, propylene glycol, 1,3-dihydroxypropane, 1,4-dihydroxybutane, and 1,6-dihydroxhexane, glycerol, 1,2,4-trihydroxybutane, 1,2,6-trihydroxyhexane, 1,1,1-trimethylolethane, 1,1,1-trimethylolpropane, pentaerythritol, polycaprolactone, xylitol, arabitol, sorbitol, and mannitol. Preferably an alkylene oxide adduct of polyhydroxyalkanes is an ethylene oxide adduct of trihydroxyalkanes. Other useful adducts include ethylene diamine, glycerin, ammonia, 1,2,3,4-tetrahydroxy butane, fructose, and sucrose.

Also preferred are poly(oxypropylene) glycols, triols, tetrols, and hexols and any of these that are capped with ethylene oxide. These polyols also include poly(oxyproyleneoxyethylene) polyols. The oxyethylene content should preferably comprise less than 80 weight percent of the total based on the total weight of the polyol and more preferably less than 40 weight percent. The ethylene oxide, when used, can be incorporated in any way along the polymer chain, for example, as internal blocks, terminal blocks, or randomly distributed blocks, or any combination thereof.

Polyisocyanate polyaddition active hydrogen-containing compounds (PIPA) can be used with the invention. PIPA compounds are typically the reaction products of TDI and triethanolamine. A method for preparing PIPA compounds can be found in, for example, U.S. Pat. No. 4,374,209 issued to Rowlands.

Another class of polyols that can be used with the invention is “a copolymer polyol,” which includes base polyols containing stably dispersed polymers such as acrylonitrile-styrene copolymers. Production of these copolymer polyols can be from reaction mixtures comprising a variety of other materials, including, for example, catalyst such as azobisisobutyronitrile; copolymer-polyol stabilizers; and chain-transfer agents such as isopropanol.

In addition to the base polyols described above, other active hydrogen-containing materials are useful with the invention. Low molecular-weight polyfunctional compounds such as glycols, glycerols, di- and tri-amino compounds, and polyfunctional amino-alcohols can be included in the formulations of the invention and are particularly useful. For example, ethylene glycol and/or diethyltoluenediamine can be used as chain extenders.

When additional isocyanate-reactive materials such as a polyol is included in a polyurea-polymer formulation of the invention, it is included in the calculation of ratio of isocyanate groups to isocyanate-reactive groups.

Additional Components

A polyurea-polymer formulation of the invention can also include known additives and other known formulation components to prepare molded polyurea polymers with desired properties. Generally any additive known to those skilled in the art to be useful in preparing polyurea-polymer formulations can be included in a formulation of the invention so long as the additive is compatible with other components in the formulation.

For example, when a foamed polymer is desired, the polyurea polymers can be prepared from a formulation including one or more blowing agents such as water, carbon dioxide, and air.

A polyurea-polymer formulation of the invention can also include a filler. Any filler generally known to one of skill in the art as useful for polyurea polymers can be used. Suitable fillers include mica, clays, glass fibers, glass beads, glass microspheres, and wollastonite.

A polyurea-polymer formulation can also include a reinforcing substrate. Any reinforcing substrate generally known to one of skill in the art as useful for polyurea polymers can be used. For example the polymers of the invention can be prepared with reinforcing mats.

Other known additives can be included in a polyurea-polymer formulation of the invention. Examples of such additives include mold-release agents (e.g., zinc stearate), surfactants (e.g., silicone surfactant), ultraviolet-light stabilizers, molecular-weight extenders, pigments, catalysts (e.g., dimethyl tin dilaurate), and fire retardants. These materials are all well known in the art.

A polyurea-polymer formulation of the invention preferably includes a polyexpoxide. A polyexpoxide suitable for use with the invention includes diglycidyl ethers of compounds containing an average of more than two, preferably not greater than 2 aromatic, cycloaliphatic, or aliphatic hydroxyl groups per molecule. Suitable polyepoxides also include a diglycidyl ether of dihydric bisphenol. Other examples are described in U.S. Pat. No. 5,525,681. A polyurea-polymer formulation can include up to about 20 weight-percent polyepoxide based on the total weight of the formulation.

Isocyanate Index

The isocyanate index of a polyurea polymer has been known to affect blister resistance of a molded polyurea polymer. The isocyanate index is the molar ratio of isocyanate groups to isocyanate-reactive groups. Conventionally the isocyanate index of formulations for RIM polyurea polymers is in a range of from 0.80 to 1.20, preferably from 0.90 to 1.10, and more preferably from 0.95 to 1.05. Notably, while increasing the isocyanate index can improve blister resistance, the molded polymer generally becomes more brittle, which is undesirable for a variety of applications. Brittleness is a significant problem at an isocyanate index of 1.40.

The isocyanate index of a polyurea-polymer formulation of the invention is desirably in a range of between about 1.05 and about 1.40, preferably in a range of between about 1.20 and about 1.40, and more preferably about 1.20.

The desirable isocyanate index may vary depending on other components added to a formulation of the invention. For example, for a polyurea-polymer formulation that further includes a polyepoxide, the isocyanate index is desirably in a range of between about 1.00 and about 1.40, preferably in a range of between about 1.05 and about 1.10, and more preferably about 1.05.

Blister resistance of a molded polyurea polymer can generally be improved by increasing an isocyanate index by a relatively small amount such as about 0.05, preferably about 0.10, and more preferably about 0.15 over a conventional molded polyurea polymer.

A molded polyurea polymer of the invention can be less brittle, as determined by Gardner Impact, than a conventional molded polyurea polymer having the same isocyanate index but being substantially free of a fatty-acid ester.

Method

A polyurea-polymer formulation of the invention can be prepared by admixing at least one of a polyisocyanate, at least one of an isocyanate-reactive material, and at least one of a fatty-acid ester. The fatty-acid ester is admixed in an amount effective for providing a molded polyurea polymer prepared from the formulation with blister resistance such that when the molded polyurea polymer is exposed to moisture and a temperature of at least about 350° F. (177° C.), the molded polyurea polymer is substantially free of blisters.

Alternatively, the fatty-acid ester is admixed in an amount effective to improve the blister resistance of a molded polyurea polymer prepared from a polyurea-polymer formulation of the invention as compared to the blister resistance of a molded polyurea polymer prepared from a polyurea-polymer formulation that is substantially free of a fatty-acid ester.

In a preferred embodiment of the invention, a method for preparing a polyurea-polymer formulation includes mixing a polyisocyanate, an isocyanate-reactive material, and a fatty-acid ester to have an isocyanate index in a range of between about 1.05 and about 1.40. When the formulation further comprises a polyepoxide, the isocyanate index is in a range of between about 1.00 and about 1.40.

When incorporating a polyexpoxide into a formulation of the invention, a polyisocyanate, a polyepoxide, an isocyanate-reactive material, and a fatty-acid ester can be admixed while heating to a temperature of about 302° F. (150° C.). Alternatively, the components are admixed at a temperature of less than about 266° F. (130° C.) and then postcured at a temperature greater than about 302° F. (150° C.). Preferably the polyepoxide and polyisocyanate are mixed together first and then the isocyanate-reactive material and the fatty-acid ester are admixed.

The components in a formulation of the invention can be mixed in any way known to those skilled in preparing polyurea-polymer formulations. For example, the components can be mixed and poured into an open mold, a process known as casting. One useful embodiment of the invention is a cellular polyurea-polymer foam prepared by mixing a polyisocyanate, a fatty-acid ester, and a polyamine in the presence of a blowing agent and injecting the forming polymer into a mold to form a molded foam.

Preferably a polyurea-polymer formulation is prepared and molded by RIM. This process is well known in the art of preparing polyurea-polymer formulations. Generally a RIM process relates to a process in which two or more highly reactive streams are brought together under high pressure in a small mixing chamber. The material mixes and flows immediately into a warm mold where the chemical reaction is completed sufficiently to allow removal of the molded polymer from the mold. The streams are, in the case of the invention, (1) a polyisocyanate stream designated the “A” stream and (2) one or more streams containing an isocyanate-reactive material and additives designated collectively as the “B” component or stream.

RIM can be performed in a closed-mold process. In closed-mold RIM, the mold is composed such that the forming polymer, upon entering the mold, pushes the air from the mold resulting in a polymer substantially free of trapped air.

RIM can also be performed in an open mold-process. The formed polyurea-polymer part is removed from the mold. The part may also be postcured by heating the molded part at an elevated temperature such as 375° F. (190° C.) for a period of time such as 30 minutes.

Molded polyurea-polymer formulations of the invention can display better heat stability, as evidenced by resistance to blistering, than conventional molded polyurea-polymer formulations. For example, a conventional RIM polyurea polymer, which has been exposed to moisture, can severely blister upon exposure to temperatures of about 365° F. (185° C.). But a molded polyurea polymer of the invention, exposed to similar amounts of moisture, can endure temperatures of at least about 350° F. (177° C.), preferably at least about 375° F. (190° C.), and more preferably at least 390° F. (199° C.), and generally greater than about (400° F.)(204° C.) without blistering.

The molded polyurea polymers of the invention can also display superior physical properties compared to conventional molded polyurea polymers. For example, a polyurea-polymer formulation of the invention that is prepared and molded by RIM can have lower heat sag, higher modulus, less brittleness as measured by Gardner Impact, higher heat-distortion temperatures, and less blistering than conventional molded polyurea polymers.

This invention will be further described by the following Example. This Example is not meant to limit this invention but to further illustrate one embodiment of the invention.

### EXAMPLES

### Example 1 and Comparative Example 2

A polyurea-polymer formulation according to the invention was prepared by admixing a polyol blend with an equivalent weight of about 280 (“B” side) and an MDI prepolymer (XUS 17054; The Dow Chemical Company; Freeport, Tex.) having about 19% mica filler (Himod 270 with SMAL surface treatment; Olgay Norton, N.C.) and having an equivalent weight of about 254 (“A” Side). The formulation had an isocyanate index of 1.05.

The polyol blend included an aromatic diamine (diethyltoluenediamine) (available from Albemarle; S.C.); a polyether polyol (a 5,000 molecular-weight ethylene-oxide capped propylene polyether triol) (XUS 14003.01; available from The Dow Chemical Company; Freeport, Tex.); a polyetherpolyamine (a polyamine having an approximate equivalent weight of about 1,000 and having difunctionality) (TR2020; available from Huntsman Corporation; Austin, Tex.), an internal-mold-release agent (zinc stearate) (available among others from Ferro Corp., Cleveland, Ohio, or Witco. Corp., Chicago, Ill.); a fatty-acid ester (jojoba oil) (available among others from Desert King Corp., Chula Vista, Calif., or Desert Whale Joboba Co., Inc., Tucson, Ariz.); a catalyst (dimethyl tin dilaurate) (UL28; available from Air Products; Allentown, Pa.); and a silicone surfactant (B8418; available from Goldschmitdt Chemical Corporation; Hopewell, Va.).

A comparative formulation was prepared like the formulation of the invention except that no jojoba oil was included in the comparative formulation.

Table 1 lists the approximate composition of the polyol blends (“B” sides) used in Example 1 and Comparative Example 2. The amounts are given in weight percent based on the weight of the polyol blend.

TABLE 1
Polyol-Blend Formulation

| | | COMPARATIVE |
|---|---|---|
| COMPONENT | EXAMPLE 1 | EXAMPLE 2 |
| Diethyltoluenediamine | 34% | 32% |
| Polyetherpolyol | 47% | 50% |
| Polyetherpolyamine | 16% | 16% |
| Zinc Stearate | 1.7% | 1.7% |
| Jojoba Oil | 1.5% | 0.0% |
| Dimethyl Tin Dilaurate | 0.10% | 0.10% |
| Silicone Surfactant | 0.30% | 0.30% |

A plaque (0.6 meters by 0.9 meters) was made under normal processing conditions using reaction injection molding. The plaque was postcured at 370+/−5 degrees F. (188° C.) for 60 minutes and then cut into squares (10 cm by 10 cm). Each square was placed into a dry box until the experiment was conducted.

For the experiment, each square was immersed in water for 48 hours at room temperature. The squares were removed from the water, dried of excess water by blotting with a paper towel, and then immediately placed in an oven at a temperature of 375° F. (190° C.), 390° F. (199° C.), or 400° F. (204° C.). After 60 minutes, the squares were removed from the oven, cooled to room temperature, and examined for blistering.

Table 2 shows the results from this testing for Example 1 and Comparative Example 2. Each square was visually examined to determine whether, and to what extent, blisters were present. A scale of 0-5 was used to subjectively determine the extent of blistering, with 0 being the best in that there were no blisters present on the square after removing it from the oven.

TABLE 2

| | | COMPARATIVE |
|---|---|---|
| | EXAMPLE 1 | EXAMPLE 2 |
| Oven Temperature | Relative Blistering | Relative Blistering |
| 375° F. (190° C.). | 0 | 0 |
| 390° F. (199° C.). | 0 | 5 |
| 400° F. (204° C.) | 0 | 5 |

1-32. (canceled)

33. A method of making a molded automobile body part which comprises:
(A) admixing a polyisocyanate, an isocyanate-reactive material and jojoba oil to form a polyurea forming mixture and introducing the polyurea forming mixture into an automotive body mold; and
(B) removing the molded polyurea polymer from the automotive body mold;
(C) exposing the removed molded polyurea polymer to a temperature of at least about 350° F. (177° C.); and
(D) isolating the resulting molded automobile body part.

34. The method of claim 33, wherein the amount of jojoba oil in the polyurea forming mixture is such that the blister resistance of the molded polyurea polymer exposed to a temperature of at least about 350° F. (177° C.) is improved compared to a polyurea forming mixture that is substantially free of jojoba oil.

35. The method of claim 34, wherein the molded automobile body part is substantially free of blisters.

36. The method of claim 33, wherein the polyisocyanate has an isocyanate index between 1.05 and 1.40.

37. The method of claim 33, wherein the polyurea forming mixture further comprises a polyepoxide.

38. The method claim 33, wherein the isocyanate-reactive material is at least one of a polyamine and a polyol.

39. The method of claim 33, wherein the jojoba oil is present in the polyurea forming mixture in an amount of at least 0.5 weight percent based on the weight of said mixture excluding the weight of said polyisocyanate.

40. The method of claim 33, wherein the polyurea forming formulation is molded by reaction injection molding.

41. The method of claim 33, wherein the molded automobile body part is automobile fascia or automobile body panels.

42. The method of claim 33, wherein the amount of jojoba oil in the polyurea forming mixture is no more than about 5.0 weight percent based on the weight of the polyurea forming mixture excluding the weight of the polyisocyanate.

43. The method of claim 33, wherein the polyurea forming mixture further comprises at least one additive selected from a chain extender, a catalyst, a surfactant and an internal-mold-release agent.

44. The method of claim 33, wherein the polyurea forming mixture contains a blowing agent and the isocyanate-reactive material is a polyamine.

45. The method of claim 40, wherein the reaction injection molding is performed in a closed mold.

46. The method of claim 40, wherein the reaction injection molding is performed in an open mold.

47. The method of claim 33, wherein the removed molded polyurea polymer is exposed in step (C) to a temperature of at least about 390° F. (199° C.).

48. A method of making a blister-resistant molded automobile body part, said method comprising:
(A) admixing a polyisocyanate, an isocyanate-reactive material, and jojoba oil to form a polyurea forming mixture;
(B) molding said mixture using reaction injection molding to form a molded automobile body part; and
(C) exposing the removed molded polyurea polymer to a temperature of at least about 350° F. (177° C.)
wherein the amount of jojoba oil in the polyurea forming mixture is such that the amount of water taken up by the molded automobile body part in step (C) is no greater than 2 weight percent.

49. The method of claim 48, wherein the isocyanate-reactive material is at least one of a polyamine and a polyol.

50. The method of claim 48, wherein the polyurea forming mixture contains at least one additive selected from a chain extender, a catalyst, a surfactant and an internal-mold-release agent.

51. The method of claim 48, wherein the polyurea forming mixture further comprises a polyepoxide.

52. The method of claim 48, wherein the removed molded polyurea polymer is exposed in step (C) to a temperature of at least about 390° F. (199° C.).
